(19) United States
(12) Patent Application Publication
(10) Pub. No.: US 2002/0049580 A1
(43) Pub. Date: Apr. 25, 2002

(54) Content providing method, content providing server, and client terminal in a content providing infrastructure

(76) Inventors: Ken Kutaragi, Kanagawa (JP); Shinichi Okamoto, Tokyo (JP); Keiso Shimakawa, Kanagawa (JP); Makoto Kubo, Tokyo (JP); Yutaka Kagiwada, Tokyo (JP)

Correspondence Address: ROSENMAN & COLIN LLP, 575 MADISON AVENUE, NEW YORK, NY, 10022-2585, US

(21) Appl. No.: 09/780,997

(22) Filed: Feb. 9, 2001

(30) Foreign Application Priority Data
Jul. 4, 2000 (JP) 2000-241862
Dec. 8, 2000 (JP) 2000-375100

(51) Int. Cl. G06F 17/20

(52) U.S. Cl. 704/1

(57) ABSTRACT

A high-security content providing system is disclosed. The content providing system includes a content provider connected to a large number of user terminals via a network. A content including user information specific to a particular user and an electronic watermark embedded therein is transmitted from the content provider to a user terminal. When the content is executed on the user terminal, the user information and the electronic watermark are checked by the user terminal or by the content provider. The content is allowed to be executed only when the checking indicates that the content is an authorized content.

### FIELD OF THE INVENTION

The present invention relates to a system for providing a so-called digital content such as game software, video software, audio software, and a computer program, and more particularly, to a high-security system for providing such a content.

### BACKGROUND OF THE INVENTION

A widely-used conventional technique of acquiring a content via a network is to specify a digital content registered on a home page and download it onto a computer of a user.

In this conventional technique, a downloaded digital content can be copied onto a medium such as a floppy disk or an optical disk, and the copied data can be used on another computer. Thus, the conventional technique has a problem that protection of the copyright of contents is not sufficient.

### SUMMARY OF THE INVENTION

It is an object of the present invention to solve the above-described problem.

According to an aspect of the present invention, there is provided a content providing method comprising: a step in which when a content is transmitted to a user, an electronic water mark is embedded in the content and at least information associated with the user to whom the content is to be transmitted is added to the content; and a step in which when the content is executed, the information associated with the user who has received the content is checked at both transmitting and receiving ends, and the execution of the content is allowed if and only if the result of the checking indicates that the content is an authorized content.

According to another aspect of the present invention, there is provided a content providing server characterized in that: when a content is transmitted to a user, the content providing server embeds an electronic water mark in the content and adds at least information associated with the user to whom the content is to be transmitted to the content; and when the content is executed, the content providing server checks the information associated with the user to whom said content has been transmitted, and gives to the user permission to execute the content if and only if the result of the checking indicates that the content is an authorized content.

According to still another aspect of the present invention, there is provided a client terminal in a content providing infrastructure, characterized in that: the client terminal stores a content in which an embedded electronic watermark is embedded and to which at least information associated with a user is added; and when the content is executed, the content is executed in accordance with information which allows the content to be executed and which is supplied from a content providing server if and only if the information associated with the user to whom the content has been provided indicates that the content is an authorized content.

According to still another aspect of the present invention, there is provided a content providing system comprising: a content provider including a content server which stores plural kinds of digital contents and also including a user database in which information associated with a user is registered; at least one user terminal; and a network for connecting the at least one user terminal to the content provider, wherein the content provider includes a user database for registering, in advance, information associated with a user received from the at least one user terminal; when the content provider receives from a user terminal a request for providing a particular content, the content provider requests the user terminal to resend the information associated with the user and transmits the requested content combined with the information associated with the user after checking that the information associated with the user is consistent with the information registered in the user database; when the content transmitted from the content provider is executed at the user terminal, the user terminal checks whether the information associated with the user included in the content is consistent with the information stored in the user terminal; and in accordance with the result of the checking performed at the user terminal, the content provider determines whether to transmit a content execution permission command to the user terminal.

According to still another aspect of the present invention, there is provided a content providing system comprising: a content provider including a content server which stores plural kinds of digital contents and also including a user database in which information associated with a user is registered; at least one user terminal; and a network for connecting the at least one user terminal to the content provider, wherein the content provider includes a user database for registering, in advance, information associated with a user received from the at least one user terminal; wherein when the content provider receives from a user terminal a request for providing a particular content, the content provider requests said user terminal to resend the information associated with the user and transmits the requested content combined with the information associated with the user after checking that the information associated with the user is consistent with the information registered in the user database; and when the content provided by the content provider is executed, the content provider requests the user terminal to resend the information associated with the user, checks whether the information associated with the user resent from the user terminal is consistent with the information registered in the user database, and then determines, in accordance with the result of the checking, whether to transmit a content execution permission command to the user terminal.

In the content providing system, the information associated with the user preferably includes at least a user name, a password, and a device ID uniquely assigned to a device of the user.

Preferably, in the content providing system, when the information associated with a user received from a user terminal is registered, in advance, in the user database of the content provider, the content provider transmits to the user a card on which a card ID is stored; and the information associated with the user includes at least a user name, a password, a device ID uniquely assigned to a device of the user, and the card ID.

Preferably, in the content providing system, the content provider further includes encryption means for encrypting the information associated with a user and embedding an electronic watermark in the content, and, when the content provider receives from a user terminal a request for providing a particular content, the content provider transmits the requested content after combining the requested content with the information associated with the user and with the electronic watermark; and the content execution permission command transmitted from the content provider serves to remove the electronic watermark.

According to still another aspect of the present invention, there is provided a content provider connected to at least one user terminal via a network, the content provider comprising: a content server which stores plural kinds of digital contents; a user database for registering, in advance, information associated with a user received from the at least one user terminal, wherein when the content provider receives from a user terminal a request for providing a particular content, the content provider requests the user terminal to resend the information associated with the user and transmits the requested content combined with the information associated with the user after checking that the information associated with said user is consistent with the information registered in the user database; and when the content transmitted from the content provider is executed, checking is performed as to whether the information associated with the user included in the content is consistent with the information stored in the user terminal, and the content provider determines, in accordance with the result of the checking, whether to transmit a content execution permission command to the user terminal.

According to still another aspect of the present invention, there is provided a content provider connected to at least one user terminal via a network, the content provider comprising: a content server which stores plural kinds of digital contents; a user database for registering, in advance, information associated with a user received from the at least one user terminal, wherein when the content provider receives from a user terminal a request for providing a particular content, the content provider requests the user terminal to resend the information associated with the user and transmits the requested content combined with the information associated with the user after checking that the information associated with the user is consistent with the information registered in the user database; and when the content transmitted from the content provider is executed, the content provider requests the user terminal to resend the information associated with the user, checks whether the information associated with the user resent from the user terminal is consistent with the information registered in the user database, and then determines, in accordance with the result of the checking, whether to transmit a content execution permission command to the user terminal.

In the content provider described above, the information associated with the user preferably includes at least a user name, a password, and a device ID uniquely assigned to a device of the user.

Preferably, in the content provider described above, when the information associated with a user received from a user terminal is registered, in advance, in the user database of the content provider, the content provider transmits to the user a card on which a card ID is stored; and the information associated with the user includes at least a user name, a password, a device ID uniquely assigned to a device of the user, and the card ID.

Preferably, in the content provider described above, the content provider further includes encryption means for encrypting the information associated with a user and embedding an electronic watermark in the content, and, when the content provider receives from a user terminal a request for providing a particular content, the content provider transmits the requested content after combining the requested content with the information associated with the user and with the electronic watermark; and the content execution permission command transmitted from the content provider serves to remove the electronic watermark.

According to still another aspect of the present invention, there is provided a content providing method for use in a content providing system comprising a content provider including a content server which stores plural kinds of digital contents, at least one user terminal, and a network for connecting the at least one user terminal to the content provider, the content providing method comprising: a step of registering, in advance, information associated with a user received from the at least one user terminal in a user database of the content provider; a step in which when the content provider receives from a user terminal a request for providing a particular content, the content provider requests the user terminal to resend the information associated with the user and transmits the requested content combined with the information associated with the user after checking that the information associated with the user is consistent with the information registered in the user database; a step in which when the content transmitted from the content provider is executed at the user terminal, the user terminal checks whether the information associated with the user included in the content is consistent with the information stored in the user terminal; and a step in which, in accordance with the result of the checking performed at the user terminal, the content provider determines whether to transmit a content execution permission command to the user terminal.

According to still another aspect of the present invention, there is provided a content providing method for use in a content providing system comprising a content provider including a content server which stores plural kinds of digital contents, at least one user terminal, a network for connecting the at least one user terminal to the content provider, the content providing method comprising: a step of registering, in advance, information associated with a user received from the at least one user terminal in a user database of the content provider; a step in which when the content provider receives from a user terminal a request for providing a particular content, the content provider requests the user terminal to resend the information associated with the user and transmits the requested content combined with the information associated with the user after checking that the information associated with the user is consistent with the information registered in the user database; and a step in which when the content transmitted from the content provider is executed, the content provider requests the user terminal to resend the information associated with the user and transmits a content execution permission command to the user terminal after checking that the information associated with the user resent from the user terminal is consistent with the information registered in the user database.

### BRIEF DESCRIPTION OF THE DRAWINGS

FIG. 1 is a general block diagram illustrating a system for providing a content;

FIG. 2 is a schematic diagram illustrating the structure of data to be provided and also illustrating elements thereof;

FIG. 3 is a flow chart illustrating the operation which is performed by a content provider in response to a registration request issued by a user;

FIG. 4 is a flow chart illustrating the operation which is performed by the content provider in response to a request for downloading of a content;

FIG. 5 is a flow chart illustrating the operation which is performed by a user terminal in response to a content execution start command;

FIG. 6 is a flow chart illustrating the operation which is performed by the content provider when a content execution start command is issued by a user terminal; and

FIG. 7 is a flow chart illustrating the operation which may be alternatively performed by the content provider when a content execution start command is issued by a user terminal.

### DESCRIPTION OF THE PREFERRED EMBODIMENTS

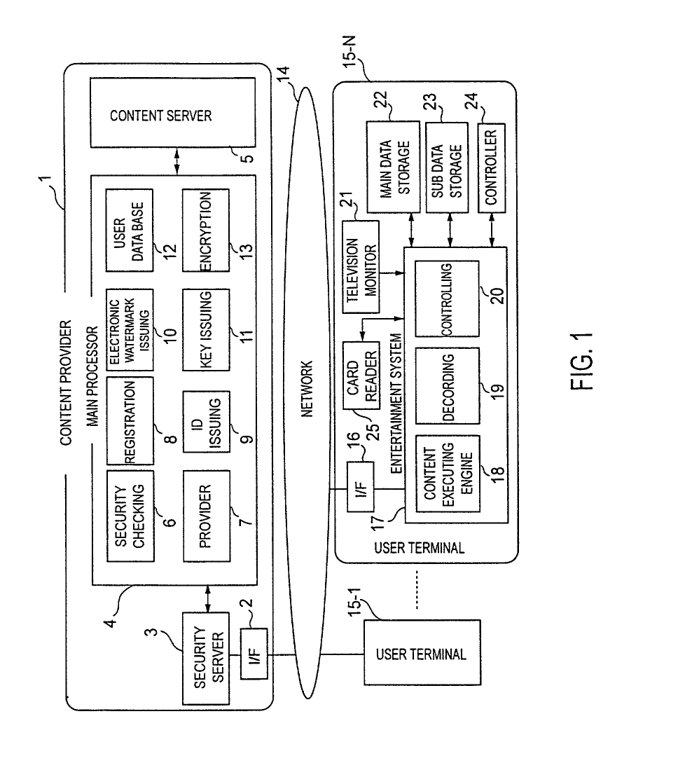

Embodiments of the present invention are described below with reference to FIGS. 1 to 7.

FIG. 1 is a general block diagram illustrating a system for providing a content.

As shown in FIG. 1, a content provider 1 is connected to a large number of user terminals 15-1 to 15-N via a network 14. Herein, the network 14 is preferably a broadband network such as a television cable network, an optical fiber network, and a broadband wireless network.

The content provider 1 includes an interface 2 for connection with the network 14, a security server 3 serving as a firewall server, a main processor 4, and a content server 5.

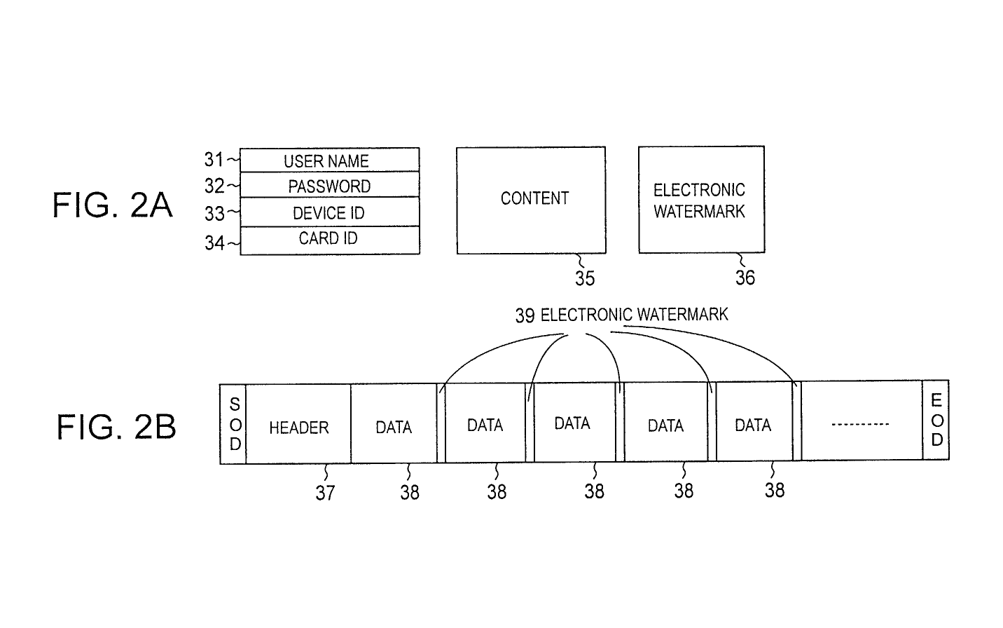

The main processor 4 includes security checking means 6 for checking the validity of user information supplied from the user terminals 15-1 to 15-N by comparing it with information stored in user database 12, a provider 7 for transmitting a content in the form of a series of data, registration means 8 for registering user information in the user database 12, ID issuing means 9 for issuing a card ID to a user who has issued a registration request, electronic watermark issuing means 10 for issuing an electronic watermark, a key issuing means 11 for issuing a key used to remove an electronic watermark from a content, and encryption means 13 for encrypting user information (such as a “user name” 31, “password” 32, “device ID” 33, and “card ID” 34 shown in FIG. 2A) stored in the user database 12 and for embedding an electronic watermark in a content. The content server 5 stores a large number of digital contents.

Each user terminal 15-1 to 15-N includes an interface 16 for connection with the network 14, an entertainment system 17 such as a game machine, a television monitor 21, a main data storage 22, a sub data storage 23, a controller 24, and a card reader 25 for reading a card ID stored on an IC card.

The main data storage 22 is preferably a high-capacity hard disk drive. The sub data storage 23 is preferably a memory card having a security capability. Preferably, the controller 24 is a controller of a home-use game machine, a pointing device, or a keyboard.

The entertainment system 17 includes a content executing engine 18 for executing a content, a decoder 19 for decoding user information, and control means 20. The decoder 19 may be realized by means of hardware or software embedded in a browser for browsing contents provided by the content provider through the network. Herein, the browser is assumed to have been installed on the main data storage 22 of the user terminals. The control means 20 is realized using a CPU and a program installed on the main data storage 22.

The process from the user registration in the content provider I to the execution of a provided content is described below.

(1) User Registration

In order to receive a content, it is required that a user have made a user registration in the content provider 1 via one of the user terminals 15-1 to 15-N. In the user registration, the user transmits his/her user name and password determined by the user, in addition to his/her address and telephone number, to the content provider 1. Furthermore, in the user registration, the content provider 1 acquires the device ID of the user terminal (one of 15-1 to 15-N) of the user. The content provider 1 issues a card ID to the user who has issued the registration request. The provider including the content provider 1 sends an IC card on which the card IC is stored.

(2) Content Transmission

When a request for a content is received from a user, the content provider 1 requests the user to send his/her user information (information associated with the user, including the user name, the password, the device ID, and the card ID of the user). The content provider 1 checks whether the user information received from the user is registered in the user database 12. If it is determined that the user information is registered in the user database 12, the content provider 1 accepts the request for the content.

Before transmitting the requested content, the user name 31, the password 32, the device ID 33, and the card ID 34 are encrypted as shown in FIG. 2A and put in the header as shown in FIG. 2B. Furthermore, electronic watermarks 36 are embedded in the content 35. An SOD (start of data) code and an EOD (end of data) code are placed at the start and the end of the data to be transmitted. Thus, the content is transmitted in the form shown in FIG. 2B. When the data is received by the user terminal (one of the user terminals 15-1 to 15-N), the data is stored, in the form as received, into the main data storage 22.

The “electronic watermark” or “digital watermark” used in the present invention serves to prevent the digital content including the “electronic watermark” or “digital watermark” embedded therein from being directly executed. The digital content can be executed only when the “electronic watermark” or “digital watermark” has been removed using particular “key information”.

(3) Execution of Content

When the user starts the operation to execute the content, the header 37 described above is first decoded, and it is checked whether the device ID 33 described in the header 37 is identical to the actual device ID of the user terminal (one of the user terminals 15-1 to 15-N) and whether the card ID 34 described in the header 37 is identical to the actual card ID described in the IC card of the user. If the checking is completed successfully, the user name, the password, the device ID, and the card ID are transmitted from the user terminal (one of 15-1 to 15-N) to the content provider 1. The content provider 1 checks the validity of the received information by comparing the received information with the information stored in the user database. If it is determined that the received information is valid, the content provider 1 transmits key information used to remove the electronic watermark from the content. The electronic watermark embedded in the content is then removed using the key information, and thus it becomes possible to execute the content.

The checking of the validity of the device ID and the card ID may be performed by the content provider 1. In this case, the content provider 1 may further request the user to return the electronic watermark embedded in the transmitted digital content and may check whether the returned electronic watermark is identical to that issued by the electronic watermark issuing means 10.

The above process is described in further detail below.

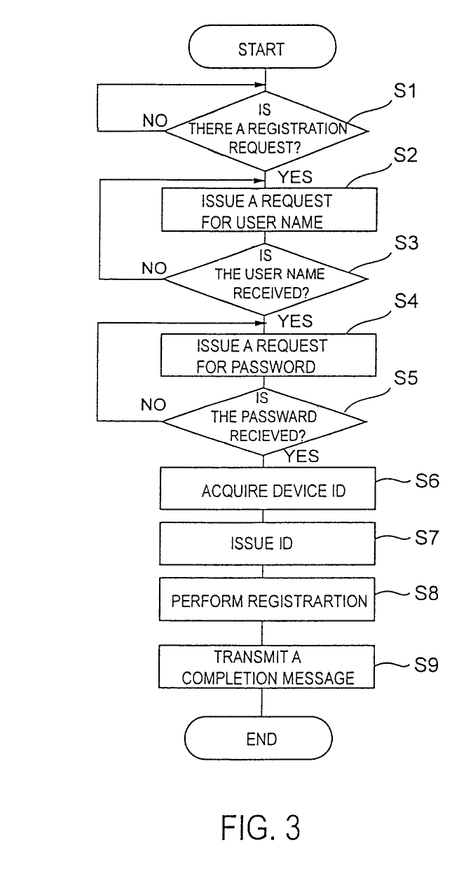

FIG. 3 is a flow chart illustrating the operation which is performed by the content provider in response to a registration request issued by a user.

In step S1, the registration means 8 determines whether a registration request is received. If yes, the process goes to step S2 and the registration means 8 requests a user terminal (one of 15-1 to 15-N), which has issued the registration request, to send the user name. In step S3, it is determined whether the user name has been received. If yes, the process goes to step S4 and the registration means 8 requests the user terminal to send the password. In step S5, it is determined whether the password has been received. If yes, the process goes to step S6 to acquire the actual device ID. Herein, the actual device ID refers to the ID uniquely assigned to and stored in the entertainment system 17 of each user terminal 15-1 to 15-N. Preferably, the actual device ID is stored in a ROM (not shown) or the sub data storage 23 of the entertainment system 17. In response to the request issued by the content provider 1, the user terminal (15-1 to 15-N) transmits its actual device ID.

In step S7, the ID issuing means 9 issues a card ID. In step S8, the registration means 8 registers the user name, the password, the actual device ID, and the actual card ID in the user database 12. In step S9, a registration completion message is transmitted to the user terminal (one of 15-1 to 15-N).

In the present invention, the information representing the actual ID registered in the user database is referred to as the “device ID”. Similarly, the ID stored on the IC card and read via the card reader 25 is referred to as the “actual card ID”, and the information representing the card ID registered in the user database is referred to as the “card ID”.

All device IDs may be stored in the database, and the registration may be refused if a received actual ID is not identical to any device ID stored in the database.

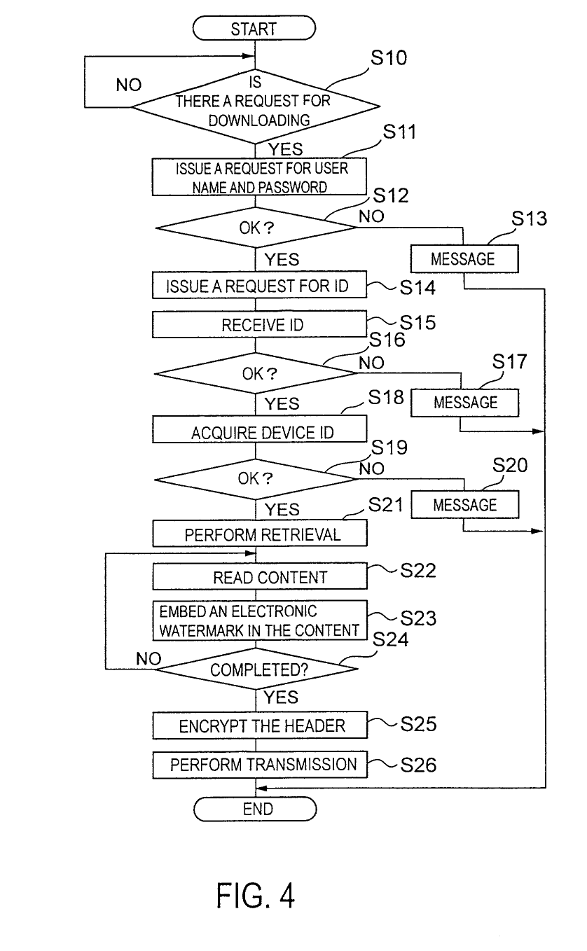

FIG. 4 is a flow chart illustrating the operation (content transmission) which is performed by the content provider in response to a content downloading request.

In step S110, the main processor 4 determines whether a downloading request (request for transmission of a content) is received from a user terminal (one of 15-1 to 15-N). If yes, the process goes to step S11, and the main processor 4 requests the user terminal (one of 15-1 to 15-N) to send its user name and password.

In step S12, the security checking means 6 determines whether the received user name and password are identical to those registered in the user database 12. If yes, the process goes to step S14 and requests the user terminal to send its actual card ID, however, if no, then the process goes to step S13 and transmits to the user terminal (one of 15-1 to 15-N) a message indicating that the received user name or password is invalid.

In step S15, the actual card ID transmitted from the user terminal (one of 15-1 to 15-N) is received. Herein, the actual card ID is a card ID which is read by the card reader 25 when the user inserts the IC card in the card reader 25. In step S16, the security checking means 6 determines whether the actual card ID received from the user terminal (one of 15-1 to 15-N) is identical to that registered in the user database 12. If yes, the process goes to step S18 and acquires the actual device ID from the user terminal (one of 15-1 to 15-N), however, if no, then the process goes to step S17 and transmits to the user terminal (one of 15-1 to 15-N) a message indicating that the received card ID is invalid.

In step S19, the security checking means 6 determines whether the actual device ID acquired directly from the user terminal (one of 15-1 to 15-N) is identical to that registered in the user database 12. If yes, the process goes to step S21 and searches the content server 5 for the content requested by the user, however, if no, then the process goes to step S20 and transmits the user terminal (one of 15-1 to 15-N) a message indicating that the received device ID is invalid.

In step S22, the provider 7 reads the retrieved content from the content server 5. In step S23, the encryption means 13 embedded, into the content, the electronic watermark issued by the electronic watermark issuing means 10. In step S24, it is determined whether all the content has been read and the electronic watermark has been embedded. If the decision in step S24 is negative, the process returns to step S22. However, if the decision in step 24 is affirmative, the process goes to step S25. In step S25, the encryption means 13 encrypts the user information and puts the encrypted user information in the header. In step S26, the provider 7 transmits the content as a series of transmission data to the user terminal (one of 15-1 to 15-N).

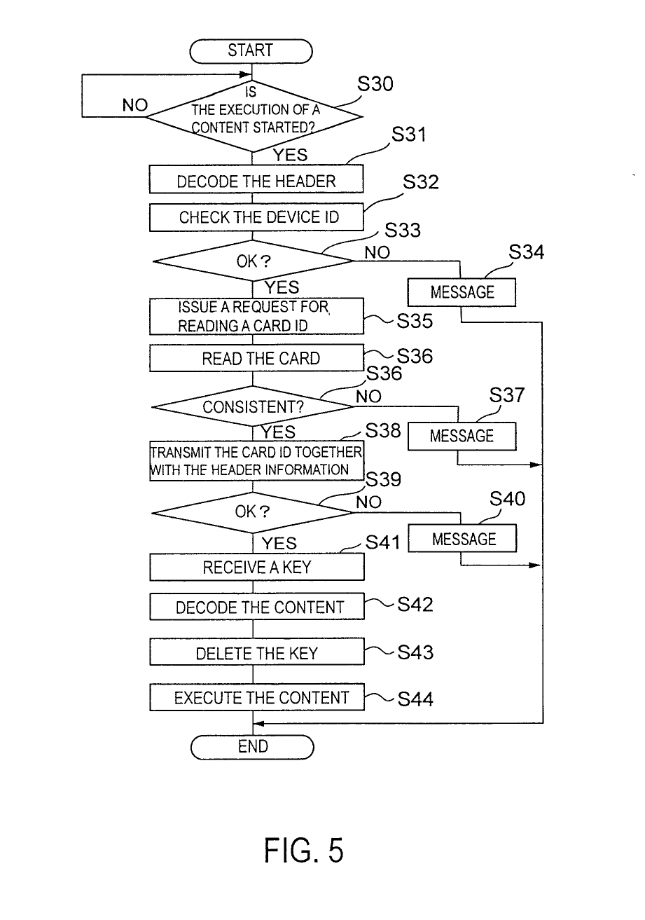

FIG. 5 is a flow chart illustrating the operation which is performed by a user terminal in response to a content execution start command.

In step S30, the control means 20 of the user terminal (one of 15-1 to 15-N) determines whether a content execution start command has been issued by the user. If yes, the process goes to step S31, and the decoder 19 decodes the information described in the header 30 of the specified content stored in the main data storage 22 thereby extracting the user name, the password, the device ID, and the card ID. In step S32, the control means 20 reads the actual device ID from the entertainment system 17 and determines whether the actual device ID is identical to the device ID extracted by the decoder 19 from the header. If yes, the process goes to step S35 and displays a message on the television monitor 21 to request the user to read the actual card ID from the IC card using the card reader 25. However, the decision in step S32 is negative, the process goes to step S34 and displays a message on the television monitor 21 to inform the user that the device ID is invalid.

In step S36, the control means 20 receives the actual card ID from the card reader 25 and determines whether the actual card ID is identical to the card ID decoded from the header. If yes, the process goes to step S38 and transmits the information decoded from the header together with the card ID read via the card reader to the content provider 1. However, if the decision in step S36 is negative, the process goes to step S40 and displays a message on the television monitor 21 to inform the user that the card ID is invalid.

In step S39, the control means 20 determines whether a message indicating the permission of executing the content has been received from the content provider 1. If yes, the process goes to step S41 and receives key information transmitted from the content provider 1. However, if the decision in step S39 is negative, the process goes to step S40 and displays a message on the television monitor 21 to inform the user that the execution of the content is not permitted.

In step S42, in accordance with the key information, the decoder 19 removes the electronic watermark from the content to be executed. In step S43, the control means 30 deletes the key information. In step S44, the content executing engine 18 starts executing the content. Note that the key information represents the data location where the electronic watermark is embedded.

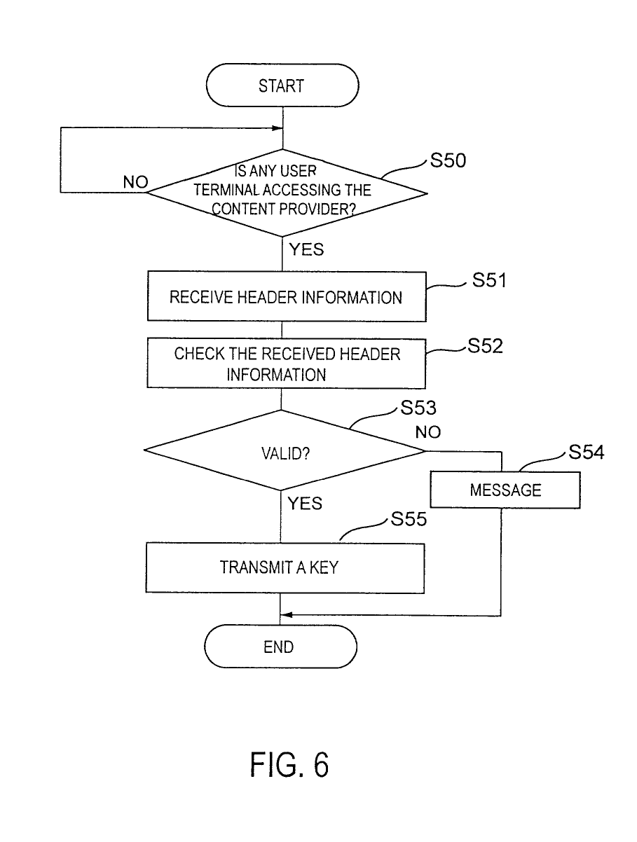

FIG. 6 is a flow chart illustrating the operation which is performed by the content provider when a content execution start command is issued by a user terminal.

When the checking of the validity is performed at the user terminal, the content provider 1 issues a content start command to the user terminal 15 in accordance with the result of the checking. Alternatively, the following steps may be taken if desired.

In step S50, the main processor 4 of the content provider 1 determines whether any of the user terminals 15-1 to 15-N is accessing the content provider 1. If yes, the process goes to step S51 and receives the header information including the decoded user name, password, device ID, and card ID from the user terminal (one of 15-1 to 15-N).

In step S52, the security checking means 6 compares the received header information with the information registered in the user database 12. In step S53, it is determined whether the received header information is identical to the information registered in the user database 21. If yes, the process goes to step S55 and transmits key information to the user terminal (one of 15-1 to 15-N). However, if the decision in step S53 is negative, the process goes to step S54 and transmits, to the user terminal (one of 15-1 to 15-N) a message indicating that the execution of the content is not permitted because the received information is not identical to the information registered in the user database 12.

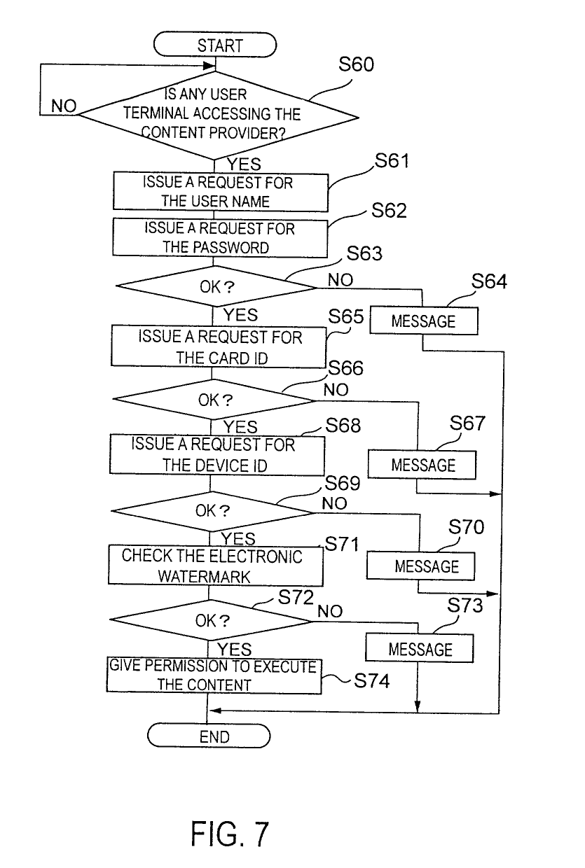

FIG. 7 is a flow chart illustrating the operation which may be alternatively performed, instead of the operation shown in FIG. 6, by the content provider when a content execution start command is issued by a user terminal.

In step S60, the main processor 4 of the content provider 1 determines whether any of the user terminals 15-1 to 15-N is accessing the content provider 1. If yes, the process goes to step S61 and requests the user terminal (one of 15-1 to 15-N) to send the user name. Furthermore, in step S62, the main processor 4 requests the user terminal to send the password.

In step S63, the security checking means 6 determines whether the user name and the password received from the user terminal (one of 15-1 to 15-N) are identical to those registered in the user database 12. If yes, the process goes to step S65 and requests the user terminal to send the actual card ID read by the card reader from the IC card of the user. However, if the decision in step S63 is negative, the process goes to step S64 and transmits, to the user terminal, a message indicating that the user name or the password input by the user is invalid.

In step S66, the security checking means 6 determines whether the actual card ID received from the user terminal (one of 15-1 to 15-N) is identical to that registered in the user database 12. If yes, the process goes to step S68 and acquires the actual device ID from the user terminal (one of 15-1 to 15-N). Furthermore, it is determined whether the acquired actual device ID is identical to the device ID registered in the user database 12. However, if the decision in step S66 is negative, the process goes to step S67 and transmits a message to notify the user that the card ID is invalid.

In step S69, it is determined whether the actual device ID received from the user terminal (one of 15-1 to 15-N) is identical to the user's device ID registered in the user database 12. If yes, the process goes to step S71 and compares the electronic watermark received from the user terminal (one of 15-1 to 15-N) with the electronic watermark issued by the electronic watermark issuing means 10. However, if the decision in step S69 is negative, the process goes to step S70 and the transmits a message indicting that the device ID is invalid.

In step S72, it is determined whether the electronic watermark received from the user terminal (one of 15-1 to 15-N) is identical to the electronic watermark issued by the electronic watermark issuing means 10. If yes, the process goes to step S74 and transmits a content execution permission command to the user terminal (one of 15-1 to 15-N). However, if the decision in step S72 is negative, the process goes to step S73 and transmits, to the user terminal (one of 15-1 to 15-N), a message indicating that the execution of the content is not permitted because the electronic watermark is invalid.

In the alternative embodiment, as described above, the entertainment system 17 extracts the electronic watermark and transmits the extracted electronic watermark to the content provider 1. The control means 20 does not issue a content execution start command to the content executing engine, unless the content execution permission command is received from the content provider 1.

In the present embodiment, as described above, because the consistency of the device ID described in the content stored in the main data storage 22 with the device ID stored in the device itself is one of conditions which should be satisfied to execute the content, the content is prevented from being executed on another device even if the same main data storage 22 is attached to the that another device. Furthermore, the use of the card ID stored on the IC card makes the security more reliable.

It is not necessarily required to use all the user name, the password, the device ID, and the card ID, for the purpose of checking the security. Instead, one of or a combination of some of these data may be used. The checking of the device ID detected directly from the device or the card ID detected from the IC card may be performed by both the user terminal (15-1 to 15-N) and the content provider or may be perform only by either the user terminal (15-1 to 15-N) or by the content provider.

The present invention can prevent a download digital content to be used onto a media such a floppy disk or an optical disk and the copied data to be used on another computer. Thus, the present invention can provide a system that the protection of the copyright of the contents is sufficient.

1. A method of providing a content, characterized in that:
when a content is transmitted to a user, an electronic water mark is embedded in said content and at least information associated with the user, to whom said content is to be transmitted, is added to said content; and
when said content is executed, said information associated with the user who has received said content is checked at both transmitting and receiving ends, and the execution of said content is allowed if and only if the result of the checking indicates that said content is an authorized content.

2. A content providing server, characterized in that:
when a content is transmitted to a user, said content providing server embeds an electronic water mark in said content and adds at least information associated with the user to whom said content is to be transmitted to said content; and
when said content is executed, said content providing server checks said information associated with the user to whom said content has been transmitted, and gives to the user permission to execute said content if and only if the result of the checking indicates that said content is an authorized content.

3. A client terminal for use in a content providing infrastructure, characterized in that:
said client terminal stores a content in which an embedded electronic watermark is embedded and to which at least information associated with a user is added; and
when said content is executed, said content is executed in accordance with information which allows said content to be executed and which is supplied from a content providing server if and only if said information associated with the user to whom said content has been provided indicates that said content is an authorized content.

4. A content providing system comprising:
a content provider including a content server which stores plural kinds of digital contents and also including a user database in which information associated with a user is registered;
at least one user terminal; and
a network for connecting said at least one user terminal to said content provider, wherein:
said content provider includes a user database for registering, in advance, information associated with a user received from said at least one user terminal;
when said content provider receives from a user terminal a request for providing a particular content, said content provider requests said user terminal to resend the information associated with said user and transmits the requested content combined with said information associated with said user after checking that said information associated with said user is consistent with the information registered in said user database;
when the content transmitted from said content provider is executed at said user terminal, said user terminal checks whether the information associated with said user included in the content is consistent with the information stored in the user terminal; and
in accordance with the result of the checking performed at said user terminal, said content provider determines whether to transmit a content execution permission command to said user terminal.

5. A content providing system comprising:
a content provider including a content server which stores plural kinds of digital contents and also including a user database in which information associated with a user is registered;
at least one user terminal;
a network for connecting said at least one user terminal to said content provider, wherein
said content provider includes a user database for registering, in advance, information associated with a user received from said at least one user terminal;
when said content provider receives from a user terminal a request for providing a particular content, said content provider requests said user terminal to resend the information associated with said user and transmits the requested content combined with said information associated with said user after checking that said information associated with said user is consistent with the information registered in said user database; and
when said content provided by said content provider is executed, said content provider requests said user terminal to resend the information associated with said user, checks whether the information associated with said user resent from said user terminal is consistent with the information registered in said user database, and then determines, in accordance with the result of the checking, whether to transmit a content execution permission command to said user terminal.

6. A content providing system according to one of claims 4 and 5, wherein said information associated with the user includes at least a user name, a password, and a device ID uniquely assigned to a device of said user.

7. A content providing system according to one of claims 4 and 5, wherein:
when the information associated with a user received from a user terminal is registered, in advance, in the user database of said content provider, said content provider transmits to said user a card on which a card ID is stored; and
said information associated with the user includes at least a user name, a password, a device ID uniquely assigned to a device of said user, and said card ID.

8. A content providing system according to one of claims 4 and 5, wherein:
said content provider further includes encryption means for encrypting the information associated with a user and embedding an electronic watermark in said content, and, when said content provider receives from a user terminal a request for providing a particular content, said content provider transmits the requested content after combining the requested content with the information associated with said user and with the electronic watermark; and
said content execution permission command transmitted from said content provider serves to remove said electronic watermark.

9. A content provider connected to at least one user terminal via a network, said content provider comprising:
a content server which stores plural kinds of digital contents; and
a user database for registering, in advance, information associated with a user received from said at least one user terminal, wherein:
when said content provider receives from a user terminal a request for providing a particular content, said content provider requests said user terminal to resend the information associated with said user and transmits the requested content combined with said information associated with said user after checking that said information associated with said user is consistent with the information registered in said user database; and
when the content transmitted from said content provider is executed, checking is performed as to whether the information associated with said user included in said content is consistent with the information stored in the user terminal, and said content provider determines, in accordance with the result of the checking, whether to transmit a content execution permission command to said user terminal.

10. A content provider connected to at least one user terminal via a network said content provider comprising:
a content server which stores plural kinds of digital contents; and
a user database for registering, in advance, information associated with a user received from said at least one user terminal, wherein:
when said content provider receives from a user terminal a request for providing a particular content, said content provider requests said user terminal to resend the information associated with said user and transmits the requested content combined with said information associated with said user after checking that said information associated with said user is consistent with the information registered in said user database; and
when said content transmitted from said content provider is executed, said content provider requests said user terminal to resend the information associated with said user, checks whether the information associated with said user resent from said user terminal is consistent with the information registered in said user database, and then determines, in accordance with the result of the checking, whether to transmit a content execution permission command to said user terminal.

11. A content providing system according to one of claims 9 and 10, wherein said information associated with the user includes at least a user name, a password, and a device ID uniquely assigned to a device of said user.

12. A content providing system according to one of claims 9 and 10, wherein
when the information associated with a user received from a user terminal is registered, in advance, in the user database of said content provider, said content provider transmits to said user a card on which a card ID is stored; and
said information associated with the user includes at least a user name, a password, a device ID uniquely assigned to a device of said user, and said card ID.

13. A content providing system according to one of claims 9 and 10, wherein
said content provider further includes encryption means for encrypting the information associated with a user and embedding an electronic watermark in said content, and, when said content provider receives from a user terminal a request for providing a particular content, said content provider transmits the requested content after combining the requested content with the information associated with said user and with the electronic watermark; and
said content execution permission command transmitted from said content provider serves to remove said electronic watermark.

14. A content providing method for use in a content providing system comprising a content provider including a content server which stores plural kinds of digital contents, at least one user terminal, and a network for connecting said at least one user terminal to said content provider, said content providing method comprising:
a step of registering, in advance, information associated with a user received from said at least one user terminal in a user database of said content provider;
a step in which when said content provider receives from a user terminal a request for providing a particular content, said content provider requests said user terminal to resend the information associated with said user and transmits the requested content combined with said information associated with said user after checking that said information associated with said user is consistent with the information registered in said user database;
a step in which when the content transmitted from said content provider is executed at said user terminal, said user terminal checks whether the information associated with said user included in the content is consistent with the information stored in the user terminal; and
a step in which, in accordance with the result of the checking performed at said user terminal, said content provider determines whether to transmit a content execution permission command to said user terminal.

15. A content providing method for use in a content providing system comprising a content provider including a content server which stores plural kinds of digital contents, at least one user terminal, and a network for connecting said at least one user terminal to said content provider, said content providing method comprising:
a step of registering, in advance, information associated with a user received from said at least one user terminal in a user database of said content provider;
a step in which when said content provider receives from a user terminal a request for providing a particular content, said content provider requests said user terminal to resend the information associated with said user and transmits the requested content combined with said information associated with said user after checking that said information associated with said user is consistent with the information registered in said user database; and
a step in which when said content transmitted from said content provider is executed, said content provider requests said user terminal to resend the information associated with said user and transmits a content execution permission command to said user terminal after checking that the information associated with said user resent from said user terminal is consistent with the information registered in said user database.
